(19) United States
(12) Patent Application Publication
(10) Pub. No.: US 2024/0321481 A1
(43) Pub. Date: Sep. 26, 2024

(54) CABLE PRODUCED BY COVERING WITH POLYTETRAFLUOROETHYLENE AND EXTRUSION MOLDING WITH A PERFLUOROALKOXY COMPOUND, AND METHOD FOR PRODUCING THE SAME

(71) Applicant: James Cheng Lee, La Habra, CA (US)

(72) Inventor: James Cheng Lee, La Habra, CA (US)

(21) Appl. No.: 18/393,879

(22) Filed: Dec. 22, 2023

Related U.S. Application Data
(60) Provisional application No. 63/454,550, filed on Mar. 24, 2023.

(30) Foreign Application Priority Data
Nov. 23, 2023 (CN) 202311573703.9

(51) Int. Cl. H01B 3/44; B29C 48/154; C08J 7/04; B29K 27/12

(52) U.S. Cl. CPC H01B 3/445; B29C 48/154; C08J 7/0427; B29K 2027/12; C08J 2327/18

(57) ABSTRACT

A method for producing a cable by covering with polytetrafluoroethylene and extrusion molding with a perfluoroalkoxy compound, including: covering an outer surface of a conductor with an insulation layer; and extrusion molding a skin layer on an outer surface of the insulation layer to form a cable. The insulation layer and the skin layer are made of polytetrafluoroethylene and a perfluoroalkoxy compound, respectively. The perfluoroalkoxy compound and polytetrafluoroethylene both have high temperature resistance, good electronic signal transmitting performance, and non-bonding surface, etc., and the perfluoroalkoxy compound has a Shore hardness of 60 to 70D, which can impart the skin layer a certain hardness, and is suitable for being extrusion molded on the outer surface of the insulation layer made of polytetrafluoroethylene, so as to support the insulation layer and prevent the insulation layer from being deformed. Therefore, the perfluoroalkoxy compound is the most suitable material for the skin layer.

### CROSS-REFERENCE TO RELATED APPLICATIONS

This application claims the priority of U.S. patent application No. 63/454,550, filed on Mar. 24, 2023 and China patent application No. 202311573703.9, filed on Nov. 23, 2023, which are incorporated herewith by reference.

### BACKGROUND OF THE INVENTION

The present invention relates to a cable and a method producing the same, in particular to a cable produced by covering with polytetrafluoroethylene and extrusion molding with a perfluoroalkoxy compound and a method for producing the same.

Generally, a cable comprises a conductor and an insulation layer. The insulation layer covers the outer surface of the conductor to protect the conductor and provide insulation effect.

The conventional producing methods for cables comprise the following two types: in the first type, the insulation layer is made of plastic, which is extrusion molded on the outer surface of the conductor; in the second type, the insulation layer is an insulation tape, which longitudinally wraps or spirally wraps around the outer surface of the conductor. The above two types of producing methods are selected depending on different transmission rates and processes.

In the application of high-speed transmission cables, in consideration of the purposes such as improving the temperature resistance of the cable, reducing the weight of the cable, reducing the signal insertion lost, and reducing the size of the cable, polytetrafluoroethylene (PTFE) microporous membrane can be used as the material of the insulation tape. The long-term working temperature of polytetrafluoroethylene can range from −200° C. to +260° C., so that it has excellent electronic signal transmission performance and non-bonding surface.

Because the polytetrafluoroethylene microporous membrane used in conventional cables is a tape material, it is not suitable for extrusion molding, but is only suitable for longitudinal wrapping or spiral wrapping

However, since the polytetrafluoroethylene microporous membrane is similar to a foam material, the insulation layer made of polytetrafluoroethylene is relatively soft, and it is required for the wrapping equipment to precisely control the tension on the insulation tape wrapped around the conductor. If the tension applied on the insulation tape by the wrapping equipment is too large, the insulation tape will be easily stretched and deformed, thereby generating wrinkles. If the tension applied on the insulation tape by the wrapping equipment is too small, the covering ability of the insulation tape is poor, a close fitting cannot be achieved, and the fitting degree between the insulation tape and the conductor is poor, which may cause a slip between the insulation tape and the conductor. In addition, it is easy to cause deformation due to the soft insulation layer during the subsequent processing of the cable (for example, manufacturing a differential signal line pair structure, adding a shielding layer, gathering into a cable, processing an outer sheath, etc.). The above-mentioned problems such as obvious deformation, wrinkles and poor roundness of the insulation layer, and eccentricity of the conductor results in the deterioration of the electronic signal transmission characteristics and mechanical characteristics of the cable to deteriorate, which causes the usable length of the cable to be reduced or even causes the cable to be unusable.

### SUMMARY OF THE INVENTION

A main object of the present invention is to provide a cable produced by covering with polytetrafluoroethylene and extrusion molding with a perfluoroalkoxy compound, and a method for producing the same, in which an insulation layer can be prevented from being deformed by supporting the insulation layer with a skin layer.

In order to achieve the aforementioned object, the present invention provides a method for producing a cable by covering with polytetrafluoroethylene and extrusion molding with a perfluoroalkoxy compound, comprising the following steps: covering an outer surface of a conductor with an insulation layer by longitudinal wrapping or spiral wrapping; and extrusion molding a skin layer on an outer surface of the insulation layer to form a cable. Wherein the insulation layer is made of polytetrafluoroethylene, and the skin layer is made of a perfluoroalkoxy compound.

In some embodiments, the skin layer has a thickness of 0.04 to 0.5 mm.

In order to achieve the aforementioned object, the present invention provides a cable produced by covering with polytetrafluoroethylene and extrusion molding with a perfluoroalkoxy compound, comprising: a conductor, an insulation layer, and a skin layer. The insulation layer covers the outer surface of the conductor by longitudinal wrapping or spiral wrapping, and the insulation layer is made of polytetrafluoroethylene. The skin layer is extrusion molded on the outer surface of the insulation layer, and the skin layer is made of a perfluoroalkoxy compound.

In some embodiments, the skin layer has a thickness of 0.04 to 0.5 mm.

The effect of the present invention is in that both of perfluoroalkoxy compound and polytetrafluoroethylene have the characteristics of high temperature resistance, good electronic signal transmitting performance, and non-bonding surface, etc., and the perfluoroalkoxy compound has a Shore hardness of 60 to 70D, which can impart the skin layer a certain hardness, and is suitable for being extrusion molded on the outer surface of the insulation layer made of polytetrafluoroethylene, so as to support the insulation layer and prevent the insulation layer from being deformed. Therefore, the perfluoroalkoxy compound is the most suitable material for the skin layer.

### BRIEF DESCRIPTION OF DRAWINGS

FIG. 1 is a flow chart of a method for producing a cable of the present invention.

FIG. 2 is a perspective view of the cable of the present invention.

FIG. 3 is a cross-sectional view taken along line III-III in FIG. 2.

FIG. 4 is a perspective view illustrating the cable of the present invention applied to a differential signal line pair structure.

FIG. 5 is a cross-sectional view taken along line V-V in FIG. 4.

FIG. 6 is a perspective view illustrating the cable of the present invention applied to a core wire with coaxial structure.

FIG. 7 is a cross-sectional view taken along line VII-VII in FIG. 6.

### DETAILED DESCRIPTION OF THE INVENTION

Herein after, a more detailed description of the embodiments of the present invention with reference to drawings and reference numerals is made for those skilled in the art to implement accordingly after reading this specification.

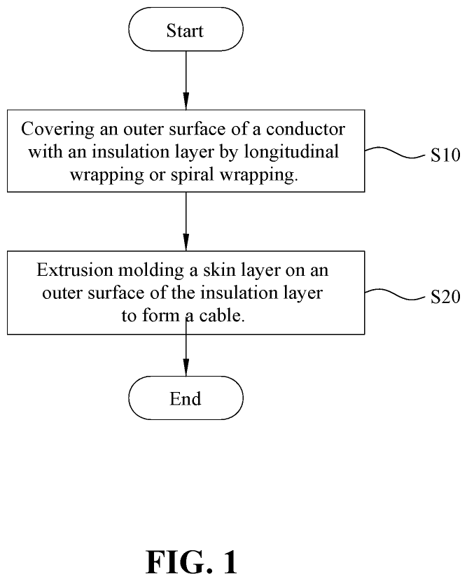

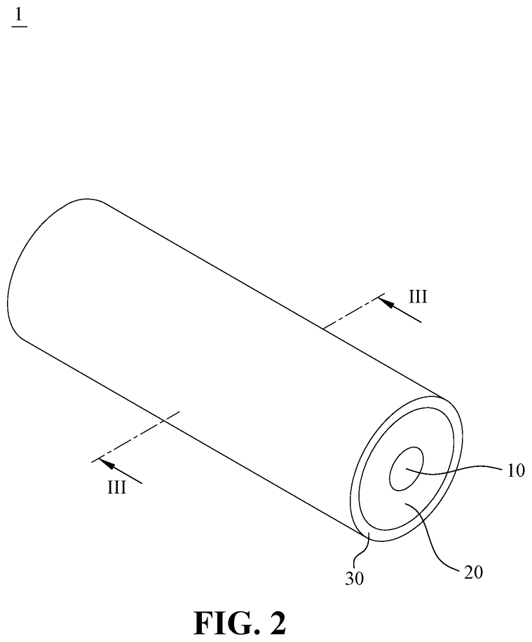

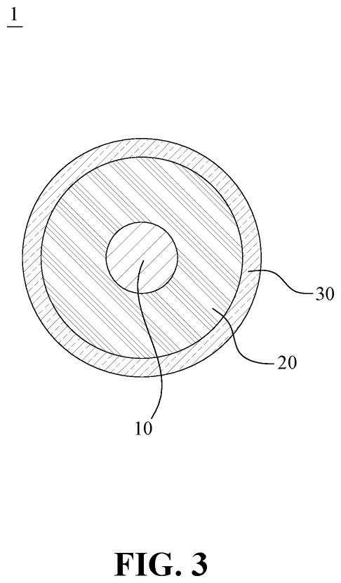

FIG. 1 is a flow chart of a method for producing a cable 1 of the present invention. FIG. 2 is a perspective view of the cable 1 of the present invention. FIG. 3 is a cross-sectional view taken along line III-III in FIG. 2. As shown in FIGS. 1, 2, and 3, the present invention provides a method for producing the cable 1 by covering with polytetrafluoroethylene and extrusion molding with a perfluoroalkoxy compound, comprising the following steps: a step S10 covering an outer surface of a conductor 10 with an insulation layer 20 by longitudinal wrapping or spiral wrapping; and a step S20 extrusion molding a skin layer 30 on an outer surface of the insulation layer 20 to form the cable 1. Wherein the insulation layer 20 is made of polytetrafluoroethylene (PTFE), and the skin layer 30 is made of a perfluoroalkoxy (PFA) compound.

As shown in FIGS. 2 and 3, the present invention provides a cable 1 produced by covering with polytetrafluoroethylene and extrusion molding with a perfluoroalkoxy compound, comprising: a conductor 10, an insulation layer 20, and a skin layer 30. The insulation layer 20 covers the outer surface of the conductor 10 by longitudinal wrapping or spiral wrapping, and the insulation layer 20 is made of polytetrafluoroethylene. The skin layer 30 is extrusion molded on the outer surface of the insulation layer 20, and the skin layer 30 is made of a perfluoroalkoxy compound.

Polytetrafluoroethylene is a foam material, so that the insulation layer 20 made of polytetrafluoroethylene is relatively soft.

TABLE 1

| | Working | Dielectric | Shore |
|---|---|---|---|
| Material | temperature (° C.) | constant | hardness |
| Polytetrafluoroethylene | 260 | 1.4~1.6 | NA |
| Perfluoroalkoxy compound | 250 | 2.03~2.1 | 60~70D |
| Fluorinated ethylene | 200 | 2.1 | 85D |
| propylene copolymer | | | |
| Ethylene tetrafluoroethylene | 150 | 2.6 | 67D |
| copolymer | | | |
| Polypropylene | 90 | 2.2 | 65D |
| High-density polyethylene | 60 | 2.3 | 58~68D |
| Polyvinyl chloride | 60~105 | 3.3 | 75~85D |
| Polyvinylidene difluoride | 150 | 8~12 | 70D |

Materials in Table 1 comprise polytetrafluoroethylene, perfluoroalkoxy compound, fluorinated ethylene propylene copolymer (FEP), ethylene tetrafluoroethylene copolymer (ETFE), polypropylene (PP), high-density polyethylene (HDPE), polyvinyl chloride (PVC), and polyvinylidene difluoride (PVDF). Except for polytetrafluoroethylene, the other materials have a Shore hardness of 50 to 80D, all of which can impart the skin layer 30 a certain hardness, and are suitable for being extrusion molded on the outer surface of the insulation layer 20 made of polytetrafluoroethylene, so as to support the insulation layer 20 and prevent the insulation layer 20 from being deformed. Because the insulation layer 20 will not be deformed, the electronic signal transmission characteristics (for example, impedance value, insertion lost, skew) and mechanical characteristics (for example, roundness, wrinkles, flexibility/bendability) of the cable 1 are more excellent.

As can be seen from Table 1, among these materials, the working temperature of the perfluoroalkoxy compound is the closest to that of polytetrafluoroethylene, and the working temperatures of both of them are significantly greater than those of the other materials. As can be seen from Table 1, among these materials, the dielectric constant of the perfluoroalkoxy compound is the closest to that of polytetrafluoroethylene, and the dielectric constants of both of them are significantly smaller than those of the other materials. Additionally, among these materials, both of perfluoroalkoxy compound and polytetrafluoroethylene have the characteristic of non-bonding surface.

Compared with the other materials, both of perfluroalkoxy compound and polytetrafluoroethylene have the characteristics of high temperature resistance, good electronic signal transmitting performance, and non-bonding surface, etc., and the perfluoroalkoxy compound has a Shore hardness of 60 to 70D, which can impart the skin layer 30 a certain hardness, and is suitable for being extrusion molded on the outer surface of the insulation layer 20 made of polytetrafluoroethylene, so as to support the insulation layer 20 and prevent the insulation layer 20 from being deformed. Therefore, the perfluoroalkoxy compound is the most suitable material for the skin layer 30.

Preferably, the skin layer 30 has a thickness of 0.04 to 0.5 mm. The skin layer 30 with this range of thickness can provide a better supporting effect, and the effect of preventing the insulation layer 20 from being the deformed is quite significant. More specifically, if the thickness of the skin layer 30 is greater, the supporting effect is the better, and the effect of preventing the insulation layer 20 from being deformed is better, but the high-frequency signal transmission will be more unstable. On the contrary, if the thickness of the skin layer 30 is less, the supporting effect is worse, and the effect of preventing the insulation layer 20 from being deformed is worse, but the high-frequency signal transmission will be more stable. The thickness of the skin layer 30 can be adjusted depending on the diameter of the conductor 10.

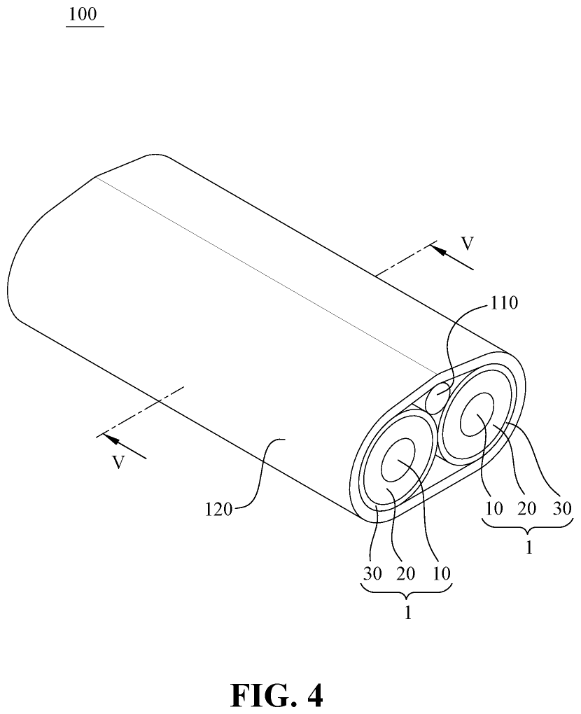

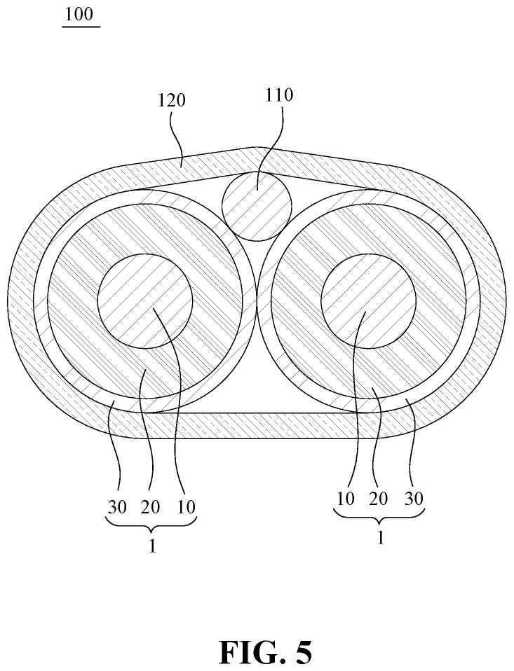

FIG. 4 is a perspective view illustrating the cable of the present invention applied to a differential signal line pair structure 100. FIG. 5 is a cross-sectional view taken along line V-V in FIG. 4. As shown in FIGS. 4 and 5, the cable 1 of the present invention can be applied to a differential signal line pair structure 100. Specifically, the present invention provides a differential signal line pair structure 100, comprising two cables 1, a ground wire 110, and a shielding layer 120. The ground wire 110 is disposed between the cables 1. The shielding layer 120 is made of aluminum foil, and covers the outer surface of the cables 1 and the outer surface of the ground wire 110.

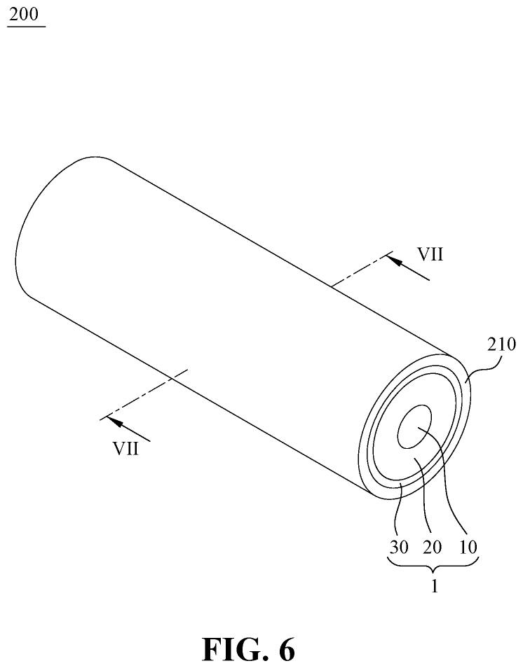

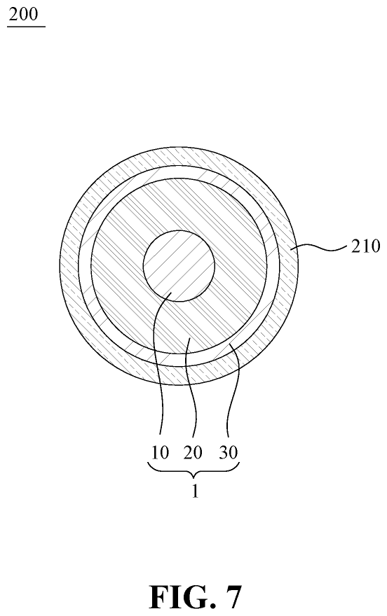

FIG. 6 is a perspective view illustrating the cable 1 of the present invention applied to a core wire with coaxial structure 200. FIG. 7 is a cross-sectional view taken along line VII-VII in FIG. 6. As shown in FIGS. 6 and 7, the cable 1 of the present invention can be applied to a core wire with coaxial structure 200. Specifically, the present invention provides a core wire with coaxial structure 200, comprising a cable 1 and a shielding layer 120. The shielding layer 210 is made of aluminum foil and covers the outer surface of the cable 1.

Those described above are only used to explain the preferred embodiments of the present invention, but not intended to limit the present invention in any form. Therefore, any modifications or changes made to the present invention under the same inventive spirit should still be included in the scope to be protected by the present invention.

1. A method for producing a cable by covering with polytetrafluoroethylene and extrusion molding with a perfluoroalkoxy compound, comprising the following steps:
covering an outer surface of a conductor with an insulation layer by longitudinal wrapping or spiral wrapping; and
extrusion molding a skin layer on an outer surface of the insulation layer to form a cable;
wherein the insulation layer is made of polytetrafluoroethylene, and the skin layer is made of a perfluoroalkoxy compound.

2. The method of claim 1, wherein the skin layer has a thickness of 0.04 to 0.5 mm.

3. A cable produced by covering with polytetrafluoroethylene and extrusion molding with a perfluoroalkoxy compound, comprising:
a conductor;
an insulation layer covering an outer surface of the conductor by longitudinal wrapping or spiral wrapping, and the insulation layer is made of polytetrafluoroethylene; and
a skin layer, which is extrusion molded on an outer surface of the insulation layer, and the skin layer is made of a perfluoroalkoxy compound.

4. The cable of claim 3, wherein the skin layer has a thickness of 0.04 to 0.5 mm.
